(19) United States
(12) Patent Application Publication
(10) Pub. No.: US 2013/0226868 A1
(43) Pub. Date: Aug. 29, 2013

(54) METHOD AND SYSTEM FOR PROPAGATION OF AMENDMENTS MADE TO A MASTER TO COPIES

(71) Applicant: ABB Technology AG, (US)

(72) Inventors: Christian Messinger, Hirschberg (DE); Kay Wilke, Hamburg (DE); Oliver Gramberg, Zurich (CH); Ralf Jeske, Petershagen (DE)

(73) Assignee: ABB Technology AG, Zurich (CH)

(21) Appl. No.: 13/858,293

(22) Filed: Apr. 8, 2013

Related U.S. Application Data
(63) Continuation of application No. PCT/EP2010/006164, filed on Oct. 8, 2010.

(51) Int. Cl. G06F 17/30

(52) U.S. Cl. CPC G06F 17/30371
USPC 707/610; 707/690

(57) ABSTRACT

A method and system are disclosed for propagation of changes or amendments, in a configuration of technical equipment such as transformers, generators, mills, and other automated machines or devices, by transfer (e.g., via a processor) of an amended configuration of a master having a specific apparatus or device to a non-limited number of duplicates of the master. Changes which have been incorporated with the master can be propagated from the master to the duplicate in a semi-automated or fully automated manner, and possible conflicts indicated automatically by graphic display.

### RELATED APPLICATIONS

This application claims priority as a continuation application under 35 U.S.C. §120 to PCT/EP2010/006164 filed as an International Application on Oct. 8, 2010 designating the U.S., the entire content of which is hereby incorporated by reference in its entirety.

### FIELD

The present disclosure refers to a method and a system for propagation of amendments in the configuration of technical equipment, e.g., transformers, generators, mills, and other automated machines or devices, by transfer of an amended configuration of a master, having a specific apparatus or device to a non-limited number of duplicates of the master.

### BACKGROUND

Many production plants have large subunits which are very similar but not identical to each other. As an example there may be several boilers in a chemical plant. Those boilers would be similar to a large extent but some aspects would be different. One aspect wherein subunits will be similar relates to their structure (e.g., the number, types, and arrangement of devices of which the subunit is made). An aspect which will almost always differ is the naming of the tags and signals.

An optimal workflow would be to finish the configuration of the first subunit, to test and optimize it, and then to copy and adapt the configuration for use with further subunits of the same type. But this is a slow process, since the work on the second subunit can only be started after the first one has finished.

The process today is that the first subunit is configured, and then this configuration is copied to the other subunits, while the optimization and test of the configuration takes place after the copying. This leads to shorter overall project execution times but to a higher engineering effort because all units have to be optimized and tested separately.

Accordingly, a challenge today is that the changes which are done to the first subunit during the test and optimization phase cannot be simply and automatically propagated to the other subunits for the following reasons:
a) In many cases, there is no formal link between master and copy,
b) there are differences between master and copy which should be kept,
c) there may be conflicts between changes done in master and in copy, and finally,
d) a completely automated process is unwanted by engineers who need to keep control of the engineered solution.

The result is that all changes which are done to the master after copying should be done to the duplicate again.

### SUMMARY

A method is disclosed for propagation of changes in a configuration of technical equipment, comprising: transferring a changed configuration of a master device having a specific apparatus or device to a non-limited number of duplicates of said master; detecting conflicts with a propagation of changes, a propagation from the master to at least one duplicate being executed by transferring a selected subset of the configuration of the master including changes; and propagating at least some of the changes which have been done with the master from the master to the at least one duplicate in a semi-automated or fully automated manner, with possible conflicts being indicated automatically by a graphic or textual display.

A system is also disclosed for propagation of changes in a configuration of technical equipment wherein two groups of objects are compared, where a second of the two groups has been created by copying a first of the two groups of objects but where, after copying, one or both groups of the two groups of objects have been changed, the system comprising: a) an input for receiving data which identifies roots of the master and the duplicate for matching; b) a comparing element for comparing and synchronizing matching objects in the first group and in the second group; and c) a display for identifying possible conflicting changes in the first group and the second group, if any.

### BRIEF DESCRIPTION OF THE DRAWINGS

By way of examples of various preferred embodiments disclosed herein, which are shown in the attached drawings, advantages of the invention shall be illustrated and described in more detail.

In this regard, the invention is not limited to the embodiments and configurations shown and illustrated in the figures but extended to other embodiments and configurations within the scope of the claims.

As shown in the drawings:

FIG. 1 shows an exemplary object structure with master and copy, before any changes, wherein only the names of the copied objects are changed to make them unique;

FIG. 2 shows the same two sets of objects as in FIG. 1 after structural changes have been made;

FIG. 3 shows an exemplary evolution of object structures “master” and “duplicate” over time and a three way comparison with a compare master after changes have been made;

FIG. 4 shows an exemplary screenshot of the system output showing matching of objects, differences detected, and change actions proposed to the user;

FIG. 5 shows an exemplary screenshot of a list of changes cases from which the user can select relevant ones; and

FIG. 6 shows an exemplary configuration where overlapping change groups present a conflict.

### DETAILED DESCRIPTION

The present disclosure is directed to a method and/or system which can avoid any excess of the efforts involved in a system today, and achieve systematically a standardization of the configuration of respective subunits of a plant.

An exemplary method is characterized in that any changes which have been done in the master are propagated from the master to the copies in a semi-automated or fully automated manner whereas possible conflicts are indicated automatically by means of graphic display.

Accordingly, an exemplary method is characterized in that the propagation of changes done in the master comprises the following:
matching, whereby the data source is analyzed to identify master and duplicate or duplicates, such that a logical link between the objects of the master and the duplicate is present;
comparing, whereby different types of changes (e.g., structural changes) are considered and checked for possible conflicts; and
synchronizing, whereby it is decided by the user which changes are approved and applied to the duplicate in order to synchronize the duplicate with the master.

Generally, the final decision should be taken by the engineer using the system, but the decision is prepared by the system whereas the term “master” and “duplicate” can, for example, refer to a large set of data objects being organized in one or more hierarchies wherein each object can have a common and a specific set of information items.

In such a case, the common information can include, e.g., an identifier like the name, a designation of the type of the object, and the creation time of the object; while the specific information, can depend on the type of the object, e.g., for an object representing a device of a certain kind, the specific information can include, among others, the configuration parameters applicable to this kind of device.

One exemplary preferred embodiment of a method disclosed herein is characterized in that with the matching step the respective data source is analyzed in order to identify whether it is master or duplicate, whereby a logical link between the objects of the master and the duplicate is present.

According to a more detailed exemplary embodiment of a method, preferably, for example, a three-way match is used wherein the master is saved in a compare master directly after copying the master data.

Changes done to the master can result in a data set master′ and changes done to any of the copies can result in a data set copy′ whereas both master′ and copy′ will be compared to the original version, the compare master, in order to identify if changes have been made to the master and/or the copies, whereas at any time when changes with the master are propagated to the duplicate, the current state of the master, master′ is stored as the compare master as basis for later synchronization.

Preferably according to another exemplary embodiment the so-called compare master is stored as an action log whereas this action log is provided to detect and to determine the side on which a change has been made even if it has been deleted in the duplicate. This action log can be considered an embodiment of a method as disclosed herein, and of a system as disclosed herein.

Another exemplary advantageous embodiment of the method provides for the matching to be based on a set of prioritized rules. The method will apply the rule with the highest priority first, and only objects not matched so far will be considered for matching with lower-priority rules. An example of a matching rule is equality of the name of the objects. Another example is that the names are not identical but similar to a certain degree. Furthermore, metrics can be used such as the type of the object, the number of matching children, the position in the tree, property values and more, and suitable combinations of these.

The user can choose which rules should be used for matching and in which order. The user can also configure the individual rules when those offer parameters.

An example is the following rule: “match by similar name”. One useful parameter may then be a “threshold” where objects are never matched when their names differ by e.g. more than 4 characters. If the engineer knows that in his project the naming is not a good way to match, he can deselect this option and choose other algorithms instead.

Hence, after the matching step, potential matches are presented to the engineer as a preferred user of the system. Furthermore it is possible to attach a weight (like “92% match”) to each match in order to point out the quality of the match to the user who may review these matches.

Either the user may manually match pairs of objects which have not been matched by the system or the user may unmatch pairs of objects which have been falsely matched. The matching step is configurable by the using engineer.

A preferred exemplary embodiment of the method provides that conflicts are resolved by the user since exemplary embodiments are also able to detect conflicts and shows these to the user. There may be simple conflicts where, e.g. both in master and in a copy a single value item has been changed to two different values. There may also be more complex conflicts where multiple changes that belong together should be propagated together. E.g., when a function block has been inserted in a control diagram and its inputs and outputs have been connected, none of these single changes makes sense to propagate on its own. The combination of these changes is called a change group. If change groups are overlapping in the master and in the copy, this presents a conflict.

A further part of the disclosure relates to a system to which the method is applied. Accordingly, this document discloses a system for propagation of changes in the configuration of technical equipment, where two groups of objects are compared, in which the second group has been created by copying the first group but after copying one or both groups of objects have been changed.

Such a system can provide for the method an appropriate means for propagation of changes in the configuration of technical equipment whereas in a first step a user or the system identifies roots of a master and copy or copies to the matching step; then in a second step the system identifies matching objects in the first group and in the second group for comparison and synchronization; in a third step the system compares objects matched in the second step and detects changes in the first group and the second group and conflicts in the changes in the first group and the second group; and finally in a fourth step the system presents the found changes and conflicts to the user for change propagation and conflict resolution.

According to an exemplary preferred embodiment, the identification of matching objects is not based only on the objects having the same ID or the same name but also on the use of other algorithms having similar names and the same type or the same number and types of children. There may be algorithms that are specifically tailored to a standardized naming scheme.

Accordingly the user decides which algorithms are to be applied for the matching step and in which order they are to be applied whereas the user parameterizes the algorithms if possible to do so.

Preferably an exemplary embodiment of the system can use a three-way comparison to determine if an identified change has been performed in the first group or in the second group.

According to another preferred exemplary embodiment, the system analyzes the two groups of objects being located in the same data set or in different data sets for changes and communicates or displays these changes to the user by means of any communication media (e.g., display), where any changes detected are done either on a structural level or for example an object-data level.

A further preferred exemplary embodiment of the system is characterized in that multiple changes are grouped if these changes depend on each other.

According to another preferred exemplary version, the system can propagate changes to links between objects in the master. The new target of the link in the duplicate is the object in the duplicate that corresponds to the new target of the link in the master as determined in the matching step. For example, if in the master an object A references an object B and is changed to reference an object C, then in the copy object A′ will be changed from referencing B′ to referencing C′ even though the names or identifiers of these objects are different from the objects to which they correspond to in the master.

Likewise it can be advantageously provided by the system that the user may filter for relevant changes by choosing relevant change cases, where each change case is a type of change which may occur for a certain type of object.

The disclosed system can offer proposals to the user regarding which changes should be propagated and which should not.

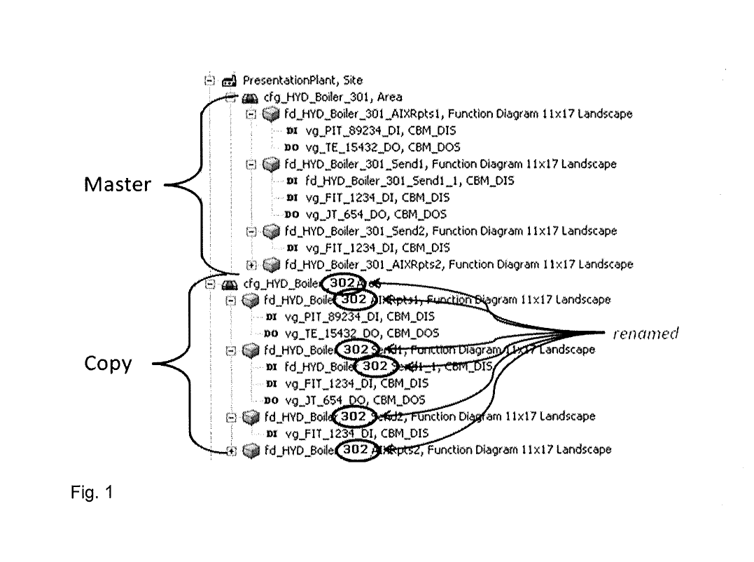

FIG. 1 shows a very simple exemplary object structure, where the site “Presentation Plant” contains two boiler areas: “cfg_HYD_Boiler_301” and “cfg_HYD_Boiler_302”, the latter being a—suitably renamed—duplicate of the first. They each contain four function diagrams and each function diagram has several signal objects (DI/DO) as children. In the matching step, the data source is analyzed to identify master and duplicate or duplicates. After this step, a logical link between the objects of the master and the duplicate is present.

If objects are arranged in a hierarchical fashion, as shown in FIG. 1, an iterative matching should be done. First it should be determined that “cfg_HYD_Boiler_301” and “cfg_HYD_Boiler_302” are the roots of sub trees that have a master-duplicate relationship. Then this should be repeated for all function diagrams below this level and again for each signal below the function diagrams.

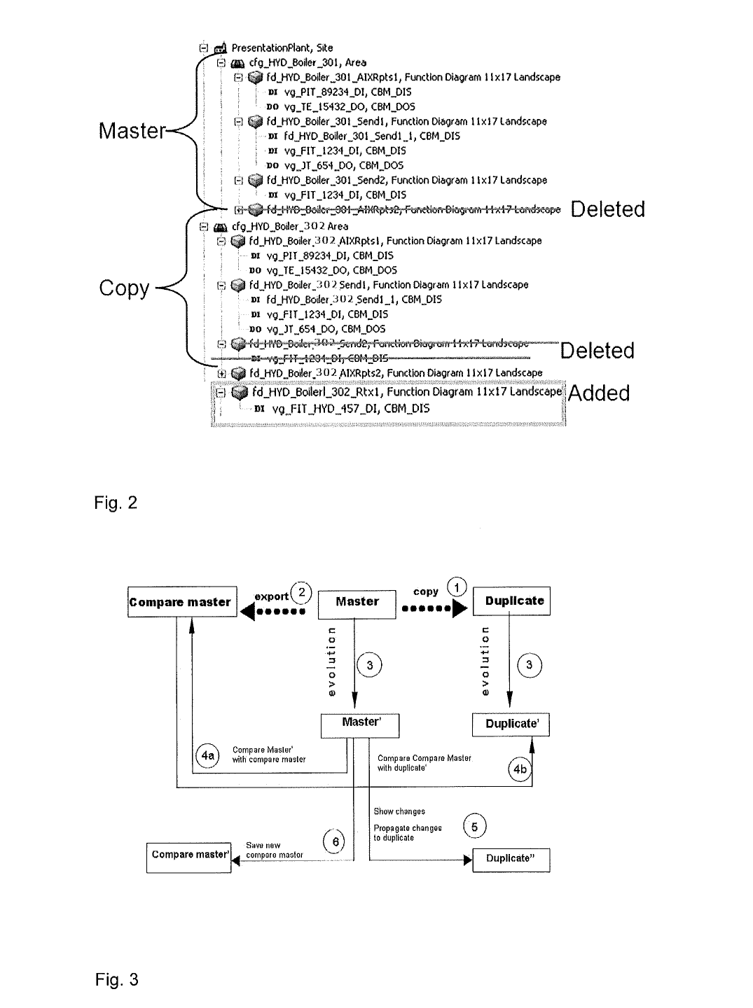

FIG. 2 shows a simple object structure with changes which may have been done to the master and the duplicate. The matching process will leave the objects “fd_HYD_Boiler_302” and “fd_HYD_BoilerI_302_Rtx1”, marked with a surrounding rectangle, and their respective children unmatched, because there are no corresponding objects in the other hierarchy. The same applies to the objects deleted in only the master or the duplicate, but not both.

There are many tools, such as directory comparing elements (e.g., specifically programmed processors with memory), which compare two trees. In nearly all cases, the comparison is done based on name or ID. Also, in exemplary embodiments determining a master-duplicate relationship is not done.

The matching step is configurable by the user. The user can choose which algorithms should be used for matching and in which order. The user can also configure the individual algorithms when those offer parameters. An example is the algorithm “match by similar name”. One useful parameter could then be a “threshold” where objects are never matched when they differ by more than 4 characters. If the engineer knows that in his project the naming is not a good way to match, this option can be deselected and other algorithms can be chosen instead.

In the comparison step, there are different types of changes to be considered. One type of change is structural changes. As shown for example in FIG. 2 there might be an object in the master which has no corresponding object in the duplicate.

Since changes occur concurrently in the master and the duplicate and no action log is written, there is no way of determining whether this object has been created in the master or if it has been deleted in the duplicate. Hence an action log can be used as a compare master to detect the side on which a change has been made.

For the comparison step, this might be negligible information, but for the next step, the change propagation, this can be crucial information: If the object has been added in the master, this change should be propagated to the duplicate. If it has been deleted in the duplicate, it is assumed that this has been done deliberately and the object should not be added back to the copy.

To be able to differentiate the two situations, the exemplary embodiments can make use of the concept of a three-way match. In FIG. 3 a scheme is shown how this process works.

After copying the master data (step 1), the master itself is saved either in a file or to some other kind of storage medium (step 2). Then the master or the duplicate or both are changed (step 3), resulting in master′ and duplicate'.

When the user now applies the system as disclosed herein, the master′ will be compared to the original version of the master which is called “compare master” (step 4a). The compare master will also be compared to the duplicate′ (step 4b).

With the information contained in the compare master, it is now possible to find out which changes have been done to the duplicate and which to the master. This method can be far superior to methods like comparing time stamps.

Every time changes are propagated to the duplicate′ (step 5), a new export of the current master′ to compare master′ can also be done (step 6).

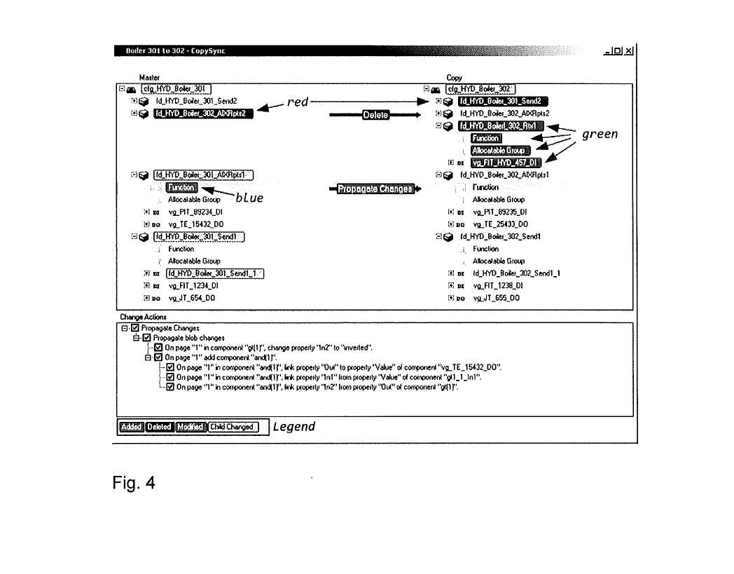

FIG. 4 shows by means of a display and screenshot how the matching is displayed. Matched nodes are displayed on the same level. If the system detected a change that can be propagated to the duplicate, then this is shown as a labeled arrow from left to right in the middle column. Changed, deleted or added items are marked as such which is done by a background color in this embodiment.

In FIG. 4, in the section below the tile “Change Actions” a change group is shown whereas it can be seen that one change action is “On page 1 add component add (1)” and this action has child actions. So, the change group includes (e.g., consists of) one added function block and three added connections which connect the new function block to the rest of the logic. Since the child actions depend on the parent action, a change group is used to build a meaningful set of items for a better overview, as well as to protect the system against inconsistencies which would result from partial execution of the change group's actions.

The comparison step is configurable by the user, in that the user can choose which types of changes are to be detected. In almost any case, the user would not like to compare the name or the creation date.

To make this easily configurable, the concept of “change cases” has been introduced herein. For a function diagram, there are around 100 change cases. They range from “constant value has changed” and “diagram formatting has changed” over “execution order has changed” to “function block has been added”.

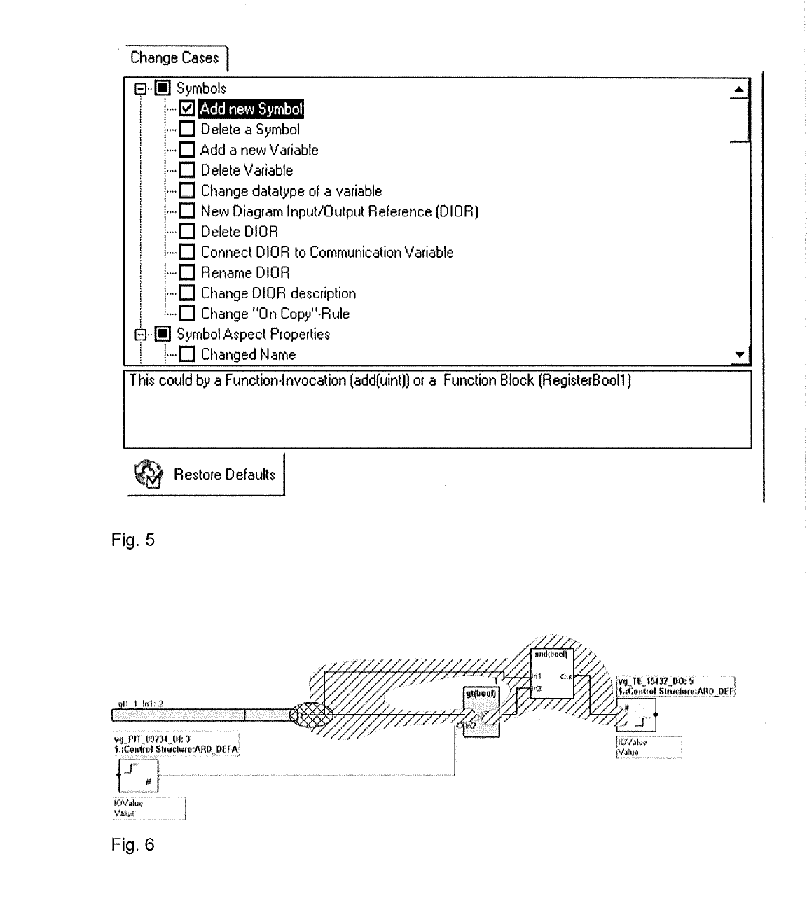

Change cases can be defined for every object type once. The user chooses during runtime which change cases to see and which should be ignored. FIG. 5 shows some of the change cases defined for function diagrams. In this dialog, a user can choose which change cases are relevant and desired.

Furthermore exemplary embodiments are also able to detect conflicts and to show these to the user. There may be direct conflicts where, e.g. both in the master and in the duplicate, a constant value has been changed. The more complex cases are found by checking if change groups are overlapping.

Here FIG. 6 shows an example whereas in the master, the “output” of the diagram reference on the top left has been negated. This is a simple change, which can also be regarded to be a change group, including (e.g., consisting of) just that change.

In FIG. 6, this change group is indicated by the oval shape with the crossed pattern. In the duplicate, an “AND” block has been inserted between the two function blocks on the right side, and connected to these, indicated by the larger shape with the hatched pattern. This is a complex change. There is a conflict between these two changes because the two marked regions overlap.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. Method for propagation of changes in a configuration of technical equipment, comprising:
transferring a changed configuration of a master device having a specific apparatus or device to a non-limited number of duplicates of said master;
detecting conflicts with a propagation of changes, a propagation from the master to at least one duplicate being executed by transferring a selected subset of the configuration of the master including changes; and
propagating at least some of the changes which have been done with the master from the master to the at least one duplicate in a semiautomated or fully automated manner, with possible conflicts being indicated automatically by a graphic or textual display.

2. Method according to claim 1, wherein the propagation of changes with the master comprises:
a) matching, whereby a master and a duplicate or duplicates are analyzed to identify which objects in the duplicate have been copied from which object from the master and thus correspond to each other;
b) comparing, whereby different types of changes are considered and checked for possible conflicts; and
c) synchronizing, whereby the user will decide which changes are applied to the duplicate in order to synchronize the duplicate with the master.

3. Method according to claim 2, wherein the matching comprises:
analyzing a respective data source to identify a master and duplicate automatically.

4. Method according to claim 2, comprising:
a three-way comparison, wherein the master is saved in a compare master directly after copying the master, changes to master result in a master', and changes to the duplicate result in a duplicate', and wherein the master′ as well as the duplicate′ will be compared to an original version of the compare master.

5. Method according to claim 2, wherein at any time changes with the master are propagated to the duplicate, the master is again saved to the compare master.

6. Method according to claim 1, wherein definite identifiers are used for the matching of an object.

7. Method according to claim 1, wherein conflicts are resolved by the user.

8. Method according to claim 1, comprising:
providing an action log in place of the compare master to detect and to determine a side on which a change has been made.

9. A system for propagation of changes in a configuration of technical equipment wherein two groups of objects are compared, where a second of the two groups has been created by copying a first of the two groups of objects but where, after copying, one or both groups of the two groups of objects have been changed, the system comprising:
a) an input for receiving data which identifies roots of the master and the duplicate for matching;
b) a comparing element for comparing and synchronizing matching objects in the first group and in the second group; and
c) a display for identifying possible conflicting changes in the first group and the second group, if any.

10. System according to claim 9, comprising:
a comparing element which identifies matching objects based on a same ID or same name, or on similar names and a same type or same number and types of child objects.

11. System according to claim 9, comprising:
any of a plurality of matching algorithms specifically tailored to a standardized naming scheme.

12. System according to claim 9, comprising:
a user input for selecting which algorithms are applied for the matching and in which order.

13. System according to claim 12, whereas the user input is configured to parameterize the algorithm.

14. System according to claim 9, comprising:
a comparing element for performing a three-way comparison to determine if an identified change has been performed in the first group or in the second group.

15. System according to claim 9, wherein the comparing element is configured to analyze the two groups of objects located in a same data set or in different data sets for changes; and the display displays the changes.

16. System according to claim 9, wherein the comparing element is configured to detect changes on a structural level and on an object-data level.

17. System according to claim 9, wherein the comparing tool is configured to group multiple changes if these changes depend on each other.

18. System according to claim 9, comprising:
a filter for filtering relevant changes by choosing relevant change cases, where each change case is a type of change which may occur for certain types of objects.

19. System according to claim 14, wherein the changes are changed links which the system will propagate between objects.

20. System according to claim 1, wherein the display presents proposals of changes which should be propagated and changes which should not be propagated.
